(19) United States
(12) Patent Application Publication
(10) Pub. No.: US 2016/0201380 A1
(43) Pub. Date: Jul. 14, 2016

(54) Door Having Electrical Contacting

(71) Applicant: KL MEGLA GMBH, Eitorf (DE)

(72) Inventor: Karl-Egon Scharder, Numbrecht (DE)

(21) Appl. No.: 14/912,873

(22) PCT Filed: Aug. 18, 2014
(86) PCT No.: PCT/EP2014/067602

§ 371 Date: Feb. 18, 2016

(30) Foreign Application Priority Data
Aug. 19, 2013 (DE) 10 2013 216 389.4
Nov. 18, 2013 (DE) 10 2013 223 459.7

(51) Int. Cl. E06B 3/46; E06B 3/50; E06B 3/48; E05D 15/06; E05F 15/60

(52) U.S. Cl. CPC E06B 3/4636; E05D 15/0604; E05D 15/063; E05F 15/60; E06B 3/481; E06B 3/50

(57) ABSTRACT

The invention relates to a door (1), which has a first door element (3). The door (1) further comprises a running rail (12), a running device (24) which is movably arranged on the running rail (12) along a longitudinal axis of the running rail (12), and a holding device (23), which is arranged on the first door element (3) and on the running device (24). Electrical contact devices (29) are mounted on the running rail (12) and cooperate with electrical contact units (32) of the running device (24).

The invention relates to a door having electrical contacting, in particular a folding door or a sliding door.

A folding door usually comprises numerous door elements, also referred to as door leaves. When the folding door is opened, the door elements fold together. In order to allow folding, it is usually the case that adjacent door elements of the folding door are connected to one another via hinges. Furthermore, each door element of the folding door is arranged on a retaining device, which, in turn, is arranged on a running device, for example a running carriage. The running device is arranged in a running rail such that it can be moved along a longitudinal axis. The running rail may be designed, for example, in the form of a ceiling rail and is thus arranged above the door elements. In the case of another known embodiment, provision is made for the running rail to be designed in the form of a floor rail and thus to be arranged beneath the door elements.

A sliding door has likewise at least one door element, which, in turn, is arranged on a running device, for example a running carriage. The running device is arranged in a running rail such that it can be moved along a longitudinal axis. The running rail may be designed in the form, for example, of a ceiling rail and is thus arranged above the door element. In the case of another known embodiment, provision is made for the running rail to be designed in the form of a floor rail and thus to be arranged beneath the door element. As an alternative, provision is made for the running rail to be fitted on a wall using so-called pre-wall installation.

Furthermore, the prior art discloses folding doors or sliding doors which have door elements made of transparent glass. It is sometimes desirable, then, to prevent anyone from seeing through the glass.

It is known to use liquid crystal films in order to prevent anyone from seeing through glass. Liquid crystals were used in the first instance in a completely different technical field, that is to say in LCD screen technology. An LCD screen is a liquid crystal screen which is used, for example, as a computer screen or television screen. LCD screen technology is based on liquid crystals influencing the polarization direction of light when a voltage is applied. An LCD screen is subdivided into numerous picture elements (pixels) which can be activated electrically. This makes it possible to provide graphic displays on the LCD screen. For color displays, use is made, per picture element (pixel), of 3 subpixels for the basic colors red, green and blue.

The use of liquid crystals, then, has also meanwhile been incorporated in glass element technology. For example, the prior art discloses a glass element provided with a liquid crystal film. For example, the liquid crystal film is arranged between a first glass panel and a second glass panel. By virtue of a voltage being applied to the liquid crystal film and of the voltage being switched on and off, poles of liquid crystals orient themselves so that the liquid crystal film becomes opaque or transparent. This makes it possible to render a glass element (for example a glass window or a glass door) transparent or opaque.

It is desirable, then, for the aforementioned liquid crystal film also to be usable in a folding door or sliding door having door elements made of glass. For this purpose, it is therefore necessary for an electric supply line to be created for a folding door or sliding door such that the liquid crystal film can be activated electrically. The movement mechanisms of the aforementioned doors, in particular the folding mechanism of the folding door, mean that this is not a trivial matter, because movements which occur on account of the folding-together action of the door elements of the folding door during opening, on account of the folding-apart action of the door elements of the folding door during closure, or during sliding action of the sliding door, often cause twisting of an electric supply line and therefore rupturing of the electric supply line.

It is therefore an object of the invention to specify a door, in particular a folding door or a sliding door, having electrical contacting which straightforwardly allows electrical activation of a liquid crystal film arranged in the door elements of the door.

This object is achieved according to the invention by a door having the features of claim 1. Further features of the invention can be gathered from the following description, from the following claims and/or the accompanying figures.

A door according to the invention has at least a first door element and/or at least a second door element. The door according to the invention also has at least one running rail. For example, the running rail is designed in the form of a profile element. The profile element is of any desired design. For example, the running rail has a hollow profile which, as seen in cross section, is closed in the direction of three sides and is open in the direction of a further side. An interior of the running rail is formed in this way. The door according to the invention also has a running device. For example, the running device is designed in the form of a running carriage. This will be discussed in more detail hereinbelow. The running device is arranged on the running rail such that it can be moved along a longitudinal axis of the running rail. For example, the running device is arranged in the aforementioned interior of the running rail.

Furthermore, the door according to the invention also has at least one retaining device, which, on the one hand, is arranged on the first door element and, on the other hand, is arranged on the running device. The retaining device is designed, for example, in the form of a clamping device. For example, it has at least a first clamping element and at least a second clamping element, wherein the first door element is retained with clamping action between the first clamping element and the second clamping element.

The running rail of the door according to the invention has at least one electrical contact device. For example, the electrical contact device is designed in the form of a metallic contact plate. In the case of one exemplary embodiment, provision is made for the electrical contact device to extend along the longitudinal axis of the running rail essentially over the entire length of the running rail. In the case of a further exemplary embodiment, provision is made in addition, or as an alternative, for the electrical contact device to be arranged on an inner side of a cavity of the running rail. For example, the cavity is the interior already mentioned above.

In the case of the door according to the invention, provision is likewise made for the running device to have at least one electrical contact unit, wherein the electrical contact unit is arranged on the electrical contact device for contact-making purposes. For example, the electrical contact unit is of pin-like design. Provision is made, in particular, to use carbon-based contact pins. However, the invention is not restricted to such a design. Rather, it is possible for the electrical contact unit to be of any design which is suitable for the invention. The running device has a first accommodating unit, which is followed by a second accommodating unit of the retaining device. The electrical contact unit has arranged on it at least one contact line, wherein the contact line is arranged in the first accommodating unit of the running device and in the second accommodating unit of the retaining device.

The door according to the invention is suitable, in particular, for activating an electric load which is arranged on the first door element. For example, the electric load is designed in the form of a liquid crystal film. By virtue of a control voltage being switched on or off, it is possible for poles of liquid crystals to be oriented such that the liquid crystal film becomes opaque or transparent. Activation of the electric load is possible in any state of the door, that is to say in the closed state, in the open state or in an interim state between the closed state and the open state. This is achieved in that sufficient contacts can be made with the electric load over the entire length of the running rail. Routing the contact line in the first accommodating unit of the running device and in the second accommodating unit of the retaining device ensures that, despite possible movement of the running device relative to the retaining device, it is not possible for the contact line to twist, and therefore for the contact line to rupture.

In the case of one embodiment of the door according to the invention, provision is made in addition, or as an alternative, for the running device to be designed in the form of a first running device and for the retaining device to be designed in the form of a first retaining device. In the case of this embodiment, provision is made for the second door element to be arranged on a second retaining device, which, in turn, is arranged on a second running device. The second retaining device may be structurally identical to the first retaining device. Furthermore, the second running device may be structurally identical to the first running device. In the case of this embodiment, the second door element is arranged on a retaining device, that is to say the second retaining device.

In the case of yet a further embodiment of the door according to the invention provision is made in addition, or as an alternative, for the running device to have at least one installation unit, on which the electrical contact unit is arranged. The installation unit has at least one guiding holder, in which the electrical contact unit and at least one elastic pressure-exerting element are arranged, wherein the elastic pressure-exerting element is arranged on the electrical contact unit such that the electrical contact unit is arranged on the electrical contact device on account of the elastic pressure-exerting element. In other words, the elastic pressure-exerting element always subjects the electrical contact unit in such a force that the electrical contact unit is in contact with the electrical contact device. This embodiment has the advantage that, on account of the elastic pressure-exerting element, the electrical contact unit is always subjected to sufficient force for contact between the electrical contact unit and the electrical contact device always to be suitably ensured.

The door according to the invention is not restricted to the use of a single electrical contact unit, of a single electrical contact device and/or of a single elastic pressure-exerting element. Rather, the number of electrical contact units, the number of electrical contact devices and/or the number of elastic pressure-exerting elements may be selected as desired. Therefore, in the case of one embodiment of the door according to the invention, provision is made in addition to, or as an alternative, for the electric contact device to be designed in the form of a first electrical contact device and for the electrical contact unit to be designed in the form of a first electrical contact unit. Furthermore, the running rail has at least a second electrical contact device. The running device has at least a second electrical contact unit. The second electrical contact unit is arranged on the second electrical contact device for contact-making purposes. In the case of yet a further embodiment of the door according to the invention, provision is made in addition, or as an alternative, for the guiding holder to be designed in the form of a first guiding holder and for the installation unit to have at least a second guiding holder, in which the second electrical contact unit and at least a second elastic pressure-exerting element are arranged. The second elastic pressure-exerting element is arranged on the second electrical contact unit such that the second electrical contact is arranged on the second electrical contact device on account of the second elastic pressure-exerting element.

In the case of one embodiment of the door according to the invention, provision is made in addition, or as an alternative, for the first electrical contact unit, the first elastic pressure-exerting element, the second electrical contact unit and the second elastic pressure-exerting element to extend along an axis which is arranged perpendicularly to the longitudinal axis of the running rail.

In the case of a further embodiment of the door according to the invention, provision is made in addition, or as an alternative, for the running device to have at least one rolling element, which is arranged on the running rail. The rolling element makes it possible for the running device to move to good effect along the longitudinal axis of the running rail. A suitable type of rolling element may be selected. For example, the rolling element is designed in the form of a running wheel. In the case of a further embodiment, the rolling element is designed, for example, in the form of a ball element and/or ball bearing. It is also the case that the door according to the invention is not restricted to the use of a single rolling element. Rather, the number of rolling elements may be selected as desired. Therefore, provision is made, for example, for the rolling element to be designed in the form of a first rolling element. The running device also has at least a second rolling element, which is arranged on the running rail. In addition, in the case of one embodiment, provision is made for the first rolling element and the second rolling element to be arranged opposite one another on the running device.

In the case of yet a further embodiment of the door according to the invention, provision is made in addition, or as an alternative, for the first accommodating unit and/or the second accommodating unit to be designed in the form of a through-passage opening. This embodiment ensures that the contact line or the contact lines can be routed from the first electrical contact unit and/or from the second electrical contact unit to an electric load (for example a liquid crystal film) arranged in the first door element and/or in the second door element.

In the case of yet a further embodiment of the door according to the invention, provision is made in addition, or as an alternative, for the retaining device to be arranged in a rotatable manner on the running device. This allows movement, that is to say rotation, of the retaining device relative to the running device. The axis-of-rotation element provided for this purpose, which is arranged on the retaining device and on the running device and about which rotation takes place, may have, for example, the first accommodating unit and the second accommodating unit. Provision is made, in particular, for the axis-of-rotation element to have a through-passage bore proceeding from a first end of the axis-of-rotation element to a second end of the axis-of-rotation element. The through-passage bore forms the first accommodating unit and the second accommodating unit. The contact line or the contact lines is or are then routed through the through-passage bore.

In the case of yet a further embodiment of the door according to the invention, provision is made in addition, or as an alternative, for the first door element to be formed from glass and/or wood, for the second door element to be formed from glass and/or wood, for the first door element to have a first liquid crystal film, for the second door element to have a second liquid crystal film, and/or for the retaining device to be designed in the form of a clamping device.

In the case of a further embodiment of the door according to the invention, provision is made in addition, or as an alternative, for the door according to the invention to be designed in the form of a folding door. The folding door has at least one hinge, which has a first hinge part and a second hinge part, wherein the first hinge part and the second hinge part are connected to one another in an articulated manner. The hinge is often also referred to as a hinge-joint. The first hinge part of the hinge is arranged on the first door element. The second hinge part of the hinge is arranged on the second door element. Provision is made, in particular, for the hinge to be arranged on longitudinal sides of the first door element and of the second door element, wherein the longitudinal sides of the first door element and the second door element are arranged opposite one another. The hinge makes it possible for the first door element and the second door element to be moved relative to one another such that the folding door can be folded together or folded apart.

In the case of a further embodiment of the door according to the invention, provision is made in addition, or as an alternative, for the door according to the invention to be designed in the form of a sliding door.

The invention will now be explained with reference to exemplary embodiments using figures, in which:

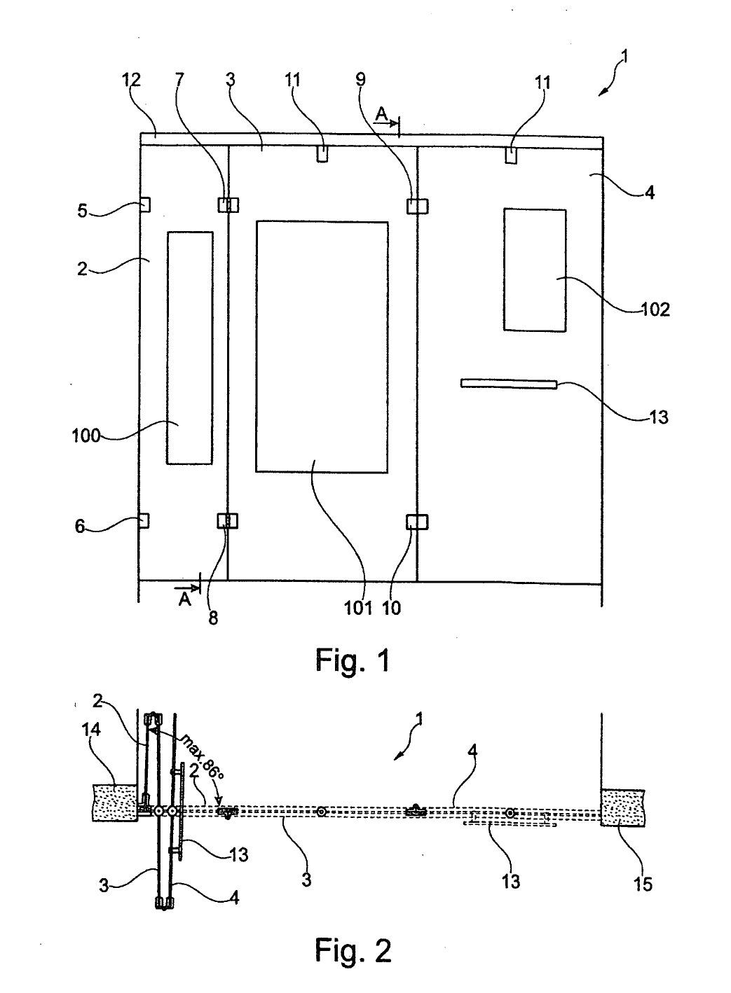

FIG. 1 shows a schematic side view of a folding door according to the invention;

FIG. 2 shows a schematic plan view of the folding door according to FIG. 1 in an open state;

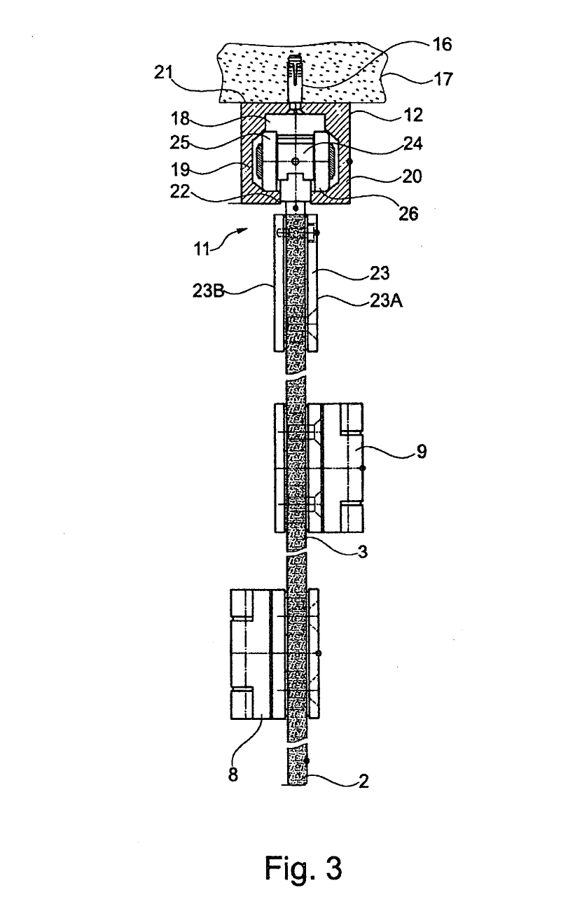

FIG. 3 shows a sectional illustration along line A-A of the folding door according to FIG. 1;

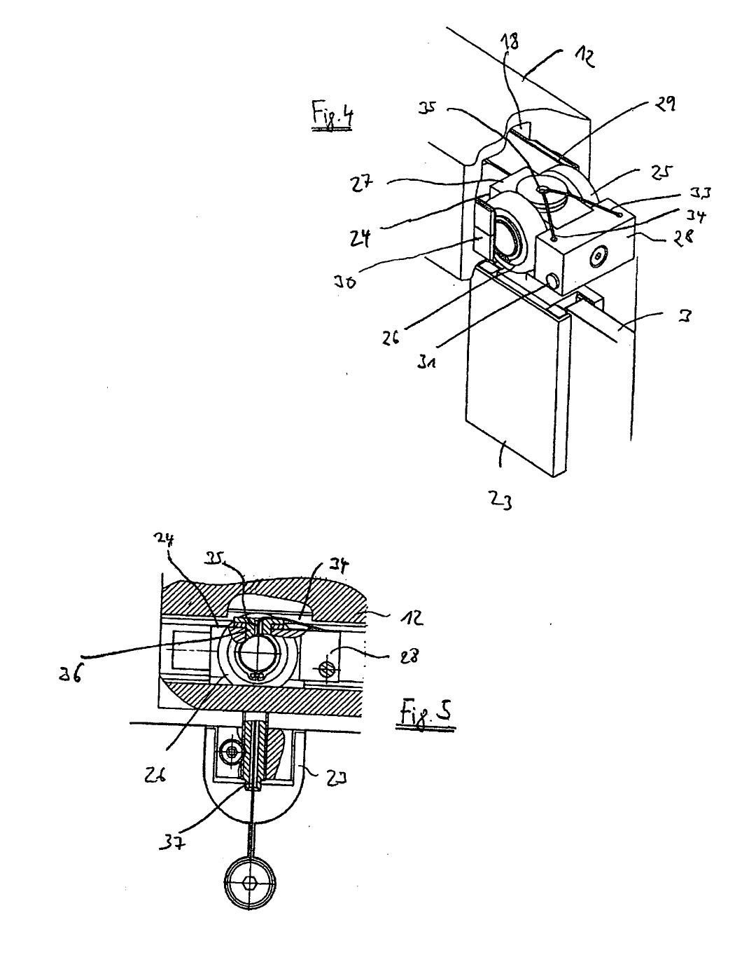

FIG. 4 shows a schematic illustration of a running rail and of a running device of the folding door according to FIG. 1;

FIG. 5 shows a sectional view of a lateral illustration of the running rail and of the running device according to FIG. 4;

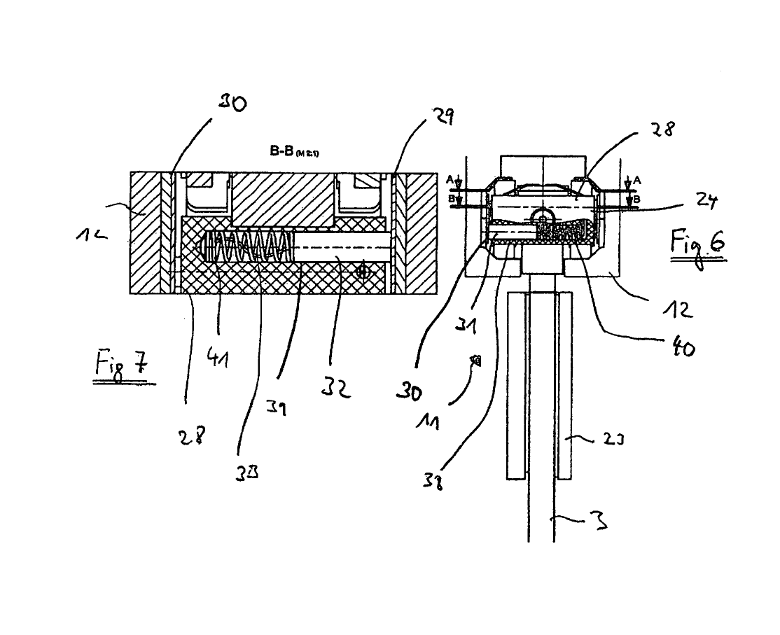

FIG. 6 shows a front view, partly in section, of the running rail and the running device according to FIG. 4;

FIG. 7 shows a sectional view along line B-B according to FIG. 6;

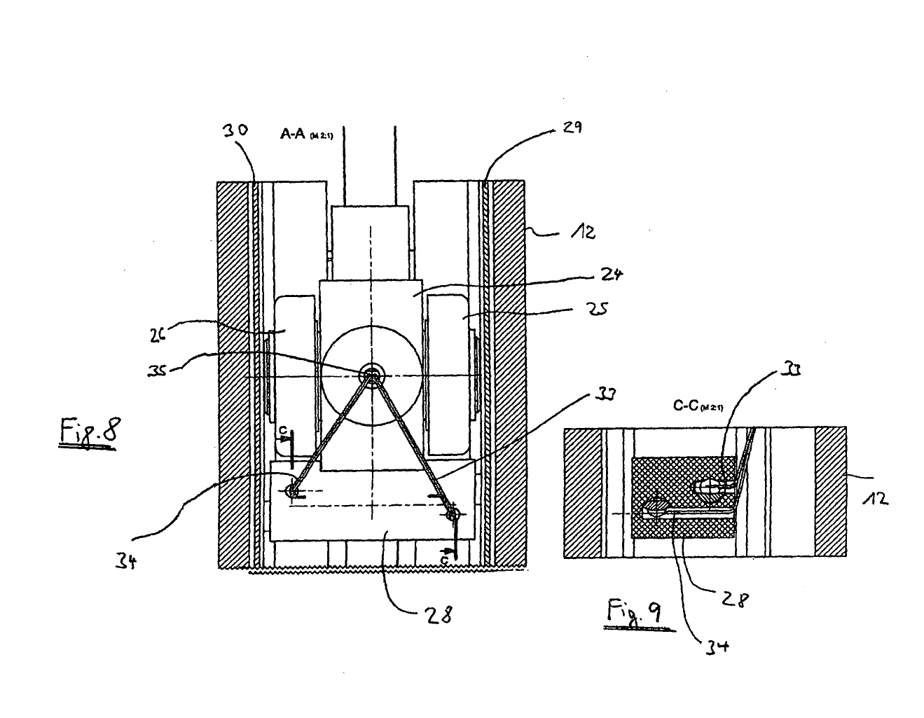

FIG. 8 shows a sectional view along line A-A according to FIG. 6;

FIG. 9 shows a sectional view along line C-C according to FIGS. 8; and

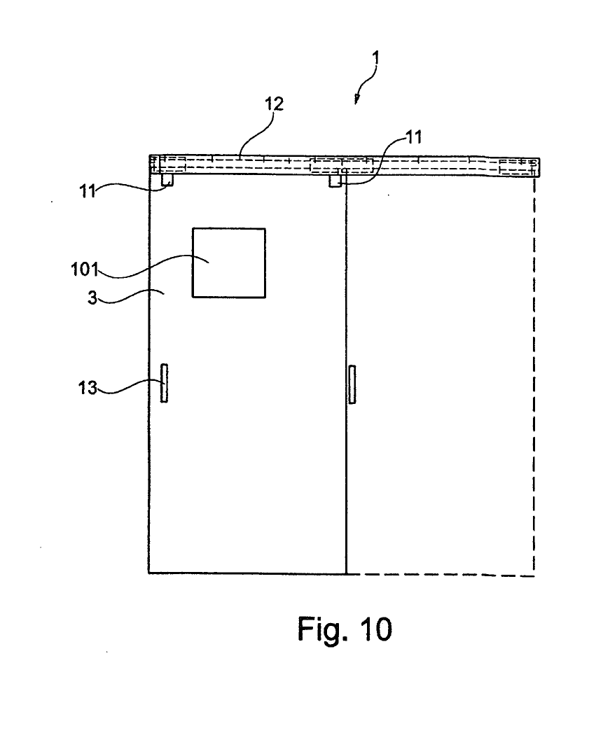

FIG. 10 shows a schematic side view of a sliding door according to the invention.

FIG. 1 shows a schematic side view of an embodiment of a door 1 in the form of a folding door according to the invention. The embodiment illustrated here has a total of three door elements, that is to say a first door element 2, a second door element 3 and a third door element 4. The first door element 2, the second door element 3 and the third door element 4, in the exemplary embodiment illustrated here, are formed from glass. It is noted explicitly, however, that at least one of the aforementioned door elements may also be formed from some other suitable material.

The first door element 2 is installed on a house or building wall by way of two hinges, that is to say a first hinge 5 and a second hinge 6. The first hinge 5 and the second hinge 6 are each designed in the form of a so-called “glass-wall” hinge. This has an angled plate, which is fastened on the house or building wall. A hinge part designed in the form of a clamping device is arranged in an articulated manner on the angled plate. The first door element 2 is retained with clamping action in the hinge part.

The first door element 2 and the second door element 3 are connected to one another in an articulated manner by a third hinge 7 and a fourth hinge 8. The third hinge 7 and the fourth hinge 8 are each arranged on sides of the first door element 2 and of the second door element 3 which are located opposite one another. Both the third hinge 7 and the fourth hinge 8 have a first hinge part and a second hinge part, which are connected to one another in an articulated manner. Accordingly, the first hinge part can be rotated relative to the second hinge part. Both the first hinge part and the second hinge part are each designed in the form of a clamping device. The first door element 2 is retained with clamping action in the first hinge part. Furthermore, the second door element 3 is retained with clamping action in the second hinge part.

The second door element 3 and the third door element 4 are connected to one another in an articulated manner by a fifth hinge 9 and a sixth hinge 10. The fifth hinge 9 and the sixth hinge 10 are each arranged on sides of the second door element 3 and of the third door element 4 which are located opposite one another. Both the fifth hinge 9 and the sixth hinge 10 have a first hinge part and a second hinge part, which are connected to one another in an articulated manner. Accordingly, the first hinge part can be rotated relative to the second hinge part. Both the first hinge part and the second hinge part are each designed in the form of a clamping device. The second door element 3 is retained with clamping action in the first hinge part. Furthermore, the third door element 4 is retained with clamping action in the second hinge part.

Both the second door element 3 and the fourth door element 4 are each arranged on a running rail 12 via a retaining unit 11. The running rail 12 is fastened on a ceiling (not illustrated). Therefore, the running rail 12 is arranged between the ceiling and the first door element 2, the second door element 3 and the third door element 4.

A handle 13 is also arranged on the third door element 4. The handle 13 serves to move the door 1 in folding-door form from a first state (for example a closed state) into a second state (for example an open state), or vice versa. FIG. 2 shows the two aforementioned states in a schematic illustration. The first state (that is to say the closed state) is illustrated by dashed lines in FIG. 2. In the second state (that is to say the open state), the first door element 2, the second door element 3 and the third door element 4 have been folded onto one another. This is achieved by a rotary movement of the individual door elements 2 to 4 relative to one another. FIG. 2 also shows a first wall 14, on which the first door element 2 is arranged. The door 1 in folding-door form serves for closing a through-passage opening between the first wall 14 and a second wall 15.

The first door element 2, the second door element 3 and the third door element 4 each has an electric load. In the case of the embodiment explained here, the electric load is a liquid crystal film. Therefore, the first door element 2 is provided with a first liquid crystal film 100. The second door element 3 is provided with a second liquid crystal film 101. The third door element 4 is provided with a third liquid crystal film 102. The liquid crystal films are illustrated schematically in FIG. 1. They may be of any dimensions and design.

FIG. 3 shows a sectional illustration along line A-A of the folding door 1 according to FIG. 1. It is possible to see the fourth hinge 8, in which the first door element 2 is retained with the clamping action, and the fifth hinge 9, in which the second door element is retained with the clamping action. The running rail 12 is fastened on a ceiling 17 of a room by means of a fastening device 16, for example a screw connection. The running rail 12 is designed in the form of a profile element. In the case of the exemplary embodiment illustrated here, the running rail 12 is of essentially U-shaped design. It has an interior 18, which is delimited by a first profile wall 19, a second profile wall 20 and a third profile wall 21. The third profile wall 21 is arranged on the ceiling 17. The first profile wall 19 and the second profile wall 20 each have a leg portion delimiting a profile opening 22. The retaining unit 11 projects through this profile opening 22.

The retaining unit 11, in the case of this exemplary embodiment, has two parts. First of all, the retaining unit 11 comprises a retaining device 23, which has a first clamping element 23A and a second clamping element 23B. The second door element 3 (or the third door element 4) is retained with clamping action between the first clamping element 23A and the second clamping element 23B. Secondly, the retaining unit 11 comprises a running device 24, which is connected to the retaining device 23 via an axis-of-rotation element. It is thus possible for the retaining device 23 to rotate relative to the running device 24.

The running device 24 has a first rolling element 25 and a second rolling element 26. Both the first rolling element 25 and the second rolling element 26 are designed in the form of a wheel. The running device 24 is arranged in the interior 18 of the running rail 12 such that the first rolling element 25 and the second rolling element 26 are arranged on inner surfaces of the interior 18. This makes it possible for the running device 24 to move within the running rail 12 along a longitudinal axis of the running rail 12. The longitudinal axis here is oriented perpendicularly to the plane of the sheet on which FIG. 3 is depicted. The retaining unit 11 serves for guiding the second door element 3 during movement from the first state of the door 1 in folding-door form into the second state of the door 1 in folding-door form (or vice versa). As already mentioned above, a retaining unit 11 of identical design is also arranged on the third door element 4. This retaining unit 11 of identical design serves for guiding the third door element 4 from the first state of the door 1 in folding-door form into the second state of the door 1 in folding-door form (or vice versa).

FIG. 4 shows a schematic illustration of the running rail 12 and of the retaining device 23, albeit from the opposite side in relation to the view of FIG. 3. Like components are provided with like designations. The running device 24 has a first running-device part 27. The first rolling element 25 and the second rolling element 26 are arranged on the first running-device part 27. Also provided is a second running-device part 28, which is arranged on the first running-device part 27 such that the running device 24 is of essentially T-shaped design. The first rolling element 25 and the second rolling element 26 are arranged in the recesses formed by the two bars of the T-shaped design.

A first electrical contact device 29 and a second electrical contact device 30 are arranged, on opposite sides, on the inner surfaces of the interior 18 of the running rail 12. Both the first electrical contact device 29 and the second electrical contact device 30 are designed in the form of metal strips or of metal plates, which extend at least in part, or preferably in their entirety, along the entire longitudinal extent of the running rail 12.

The second running-device part 28 is basically an installation unit for a first electrical contact unit and a second electrical contact unit (not illustrated in FIG. 4). This will be discussed in more detail hereinbelow. The first electrical contact unit 31 is connected to a first electrical contact line 33. The second electrical contact unit is connected to a second electrical contact line 34. The first electrical contact line 33 and the second electrical contact line 34 are routed out of the second running-device part 28 and are then arranged in a first accommodating unit 35 in the form of a through-passage opening. The first accommodating unit 35 is followed by a second accommodating unit 37 in the form of a through-passage opening (cf. FIG. 5). The first accommodating unit 35 is arranged in the region of the running device 24. In contrast, the second accommodating unit 37 is arranged in the region of the retaining device 23. As already mentioned above, the running device 24 is connected to the retaining device 23 such that it can be rotated via an axis-of-rotation element. The axis-of-rotation element is designated by reference sign 3.6 in FIG. 5. The axis-of-rotation element 36 has a central through-passage bore which, in a first portion, forms the first accommodating unit 35 and, in a second portion, forms the second accommodating unit 37. The first electrical contact line 33 and the second electrical contact line 34 are routed through the first accommodating unit 35 and the second accommodating unit 37. They are then connected to electric loads, for example to the aforementioned liquid crystal films 101 and 102, for activation of the same. The first liquid crystal film 100 is activated via lines which are routed to the liquid crystal film 101 by way of the first hinge 5 and of the second hinge 6.

FIG. 6 shows a front view, partly in section, of the running rail 12 and the retaining device 23. FIG. 7 shows an enlarged sectional view along line B-B according to FIG. 6. Like components are provided with like designations. Both the first electrical contact unit 31 and the second electrical contact unit 32 are arranged in a second running-device part 28. The two contact units 31 and 32 are of coal-based pin-like design. The first electrical contact unit 31 and the second electrical contact unit 32 here are offset in relation to one another in a step-like manner. The first electrical contact unit 31 is arranged in a first guiding holder 38. The first guiding holder 38, in the case of this exemplary embodiment, is designed in the form of a bore which has an opening toward the side on which the second electrical contact device 30 is arranged. The first guiding holder 38 also has arranged in it a first elastic pressure-exerting element 40, which interacts with one end of the first electrical contact unit 31. The first elastic pressure-exerting element 40 butts, by way of another end, against an inner wall of the first guiding holder 38. The first elastic pressure-exerting element 41 basically ensures that the first electrical contact unit 31 is always in contact with sufficient extent with the second electrical contact device 30. The same applies to the second electrical contact unit 32. The second electrical contact unit 32 is arranged in a second guiding holder 39. The second guiding holder 39, in the case of this exemplary embodiment, is designed in the form of a bore which has an opening toward the side on which the first electrical contact device 29 is arranged. The second guiding holder 39 also has arranged in it a second elastic pressure-exerting element 41, which interacts with one end of the second electrical contact unit 32. The second elastic pressure-exerting element 41 butts, by way of another end, against an inner wall of the second guiding holder 39. The second elastic pressure-exerting element 41 basically ensures that the second electrical contact unit 32 is always in contact with sufficient extent with the first electrical contact device 29. It can also be seen in FIG. 7 that the first electrical contact line 33 is arranged on the second electrical contact unit 32.

FIG. 8 is an enlarged sectional view along line A-A according to FIG. 6. FIG. 9 is an enlarged sectional view along line C-C according to FIG. 8.

Like components are provided with like designations. FIGS. 8 and 9, once again, depict the offset arrangement of the first electrical contact unit 31 and of the second electrical contact unit 32 (not illustrated in FIGS. 8 and 9) in the second running-device part 28 and therefore the offset routing of the first electrical contact line 33 and of the second electrical contact line 34 out of the second running-device part 28. The offset arrangement is advantageous since the first guiding holder 38 and the second guiding holder 39 can thus be dimensioned such that it is possible to provide elastic pressure-exerting elements 40 and 41 which are of a sufficient size, and exert sufficient force, to ensure that sufficient contact is always made.

FIG. 10 shows a schematic side view of an embodiment of a door 1 in the form of a sliding door according to the invention. The exemplary embodiment of FIG. 10 is based on the exemplary embodiment of FIG. 1. Like components are provided with like designations. However, the exemplary embodiment of FIG. 10 differs in that the embodiment illustrated here has one door element, that is to say the second door element 3. The second door element 3, in the case of the exemplary embodiment illustrated here, is formed from glass. The second door element 3 is arranged on the running rail 12 via the retaining units 11 such that the second door element 3 can be slid from a first position into a second position. The running rail 12, in the case of this exemplary embodiment, is designed in the form of a ceiling rail and is thus arranged above the second door element 3. In the case of another known embodiment, provision is made for the running rail 12 to be designed in the form of a floor rail and thus to be arranged beneath the second door element 3. As an alternative, provision is made for the running rail 12 to be fitted in a wall using so-called pre-wall installation.

The features of the invention which are disclosed in the present description, in the drawings and in the claims may be pertinent both individually and in any desired combinations for the purpose of realizing the various embodiments of the invention.

### List of Designations

1 door
2 first door element
3 second door element
4 third door element
5 first hinge
6 second hinge
7 third hinge
8 fourth hinge
9 fifth hinge
10 sixth hinge
11 retaining unit
12 running rail
13 handle
14 first wall
15 second wall
16 fastening device
17 ceiling
18 interior
19 first profile wall
20 second profile wall
21 third profile wall
22 profile opening
23 retaining device
23A first clamping element
23B second clamping element
24 running device
25 first rolling element
26 second rolling element
27 first running-device part
28 second running-device part
29 first electrical contact device
30 second electrical contact device
31 first electrical contact unit
32 second electrical contact unit
33 first electrical contact line
34 second electrical contact line
35 first accommodating unit
36 axis-of-rotation element
37 second accommodating unit
38 first guiding holder
39 second guiding holder
40 first elastic pressure-exerting element
41 second elastic pressure-exerting element
100 first liquid crystal film
101 second liquid crystal film
102 third liquid crystal film

1. A door having
a first door element,
a running rail,
a running device, which is arranged on the running rail such that it can be moved along a longitudinal axis of the running rail, and having
a retaining device, which is arranged on the first door element and which is arranged on the running device,
wherein
the running rail has a first electrical contact device,
the running device has a first electrical contact unit, which is arranged on the first electrical contact device for contact-making purposes,
the running device has a first accommodating unit, which is followed by a second accommodating unit of the retaining device,
the first electrical contact unit has arranged on it a contact line, which is arranged in the first accommodating unit of the running device and in the second accommodating unit of the retaining device, and wherein
the first accommodating unit and/or the second accommodating unit have/has a through-passage opening.

2. The door as claimed in claim 1, wherein the door has at a second door element.

3. The door as claimed in claim 1, wherein
the running device has an installation unit, on which the first electrical contact unit is arranged,
the installation unit has a first guiding holder, in which the first electrical contact unit and a first elastic pressure-exerting element are arranged, and wherein
the elastic pressure-exerting element is arranged on the first electrical contact unit such that the first electrical contact unit is arranged on the first electrical contact device on account of the elastic pressure-exerting element.

4. The door as claimed in claim 1, wherein
the running rail has a second electrical contact device,
the running device has a second electrical contact unit, and wherein
the second electrical contact unit is arranged on the second electrical contact device for contact-making purposes.

5. The door as claimed in claim 3, wherein
the running rail has a second electrical contact device,
the running device has a second electrical contact unit,
the installation unit has a second guiding holder, in which the second electrical contact unit and a second elastic pressure-exerting element are arranged, and wherein
the second elastic pressure-exerting element is arranged on the second electrical contact unit such that the second electrical contact unit is arranged on the second electrical contact device on account of the second elastic pressure-exerting element.

6. The door as claimed in claim 5, wherein the first electrical contact unit, the first elastic pressure-exerting element, the second electrical contact unit and the second elastic pressure-exerting element extend along an axis which is arranged perpendicularly to the longitudinal axis of the running rail.

7. The door as claimed in claim 1, wherein the running device has a first rolling element, which is arranged on the running rail.

8. The door as claimed in claim 7, wherein
the first rolling element includes a running wheel, or a ball bearing.

9. The door as claimed in claim 7, wherein
the running device has a second rolling element, which is arranged on the running rail, and wherein
the first rolling element and the second rolling element are arranged opposite one another on the running device.

10. The door as claimed in claim 1, wherein the retaining device is arranged in a rotatable manner on the running device.

11. The door as claimed in claim 1, wherein the door has at least one feature as follows:
the first door element is formed from glass and/or wood,
the first door element has a first liquid crystal film,
or
the retaining device includes a clamping device.

12. The door as claimed in claim 1, wherein the door is a folding door, and wherein the door has a hinge, wherein the hinge has a first hinge part and a second hinge part, wherein the first hinge part and the second hinge part are connected to one another in an articulated manner, wherein the first hinge part is arranged on the first door element, and wherein the second hinge part is arranged on a second door element.

13. The door as claimed in claim 1, wherein the door is a sliding door.

14. The door as claimed in claim 1, wherein
the running device is connected to the retaining device such that it can be rotated via an axis-of-rotation element,
the axis-of-rotation element has a central through-passage bore which, in a first portion, forms the first accommodating unit and, in a second portion, forms the second accommodating unit, and wherein
the contact line is routed through the first accommodating unit and the second accommodating unit.

15. The door as claimed in claim 4, wherein the first electrical contact unit and the second electrical contact unit are offset in relation to one another in a step-like manner.

16. The door as claimed in claim 5, wherein the first electrical contact unit and the second electrical contact unit are offset in relation to one another in a step-like manner.

17. The door as claimed in claim 2, wherein
the running device has an installation unit, on which the first electrical contact unit is arranged,
the installation unit has a guiding holder, in which the first electrical contact unit and an elastic pressure-exerting element are arranged, and wherein
the elastic pressure-exerting element is arranged on the first electrical contact unit such that the first electrical contact unit is arranged on the first electrical contact device on account of the elastic pressure-exerting element.

18. The door as claimed in claim 8, wherein
the running device has a second rolling element, which is arranged on the running rail, and wherein
the first rolling element and the second rolling element are arranged opposite one another on the running device.
